(19) United States
(12) Patent Application Publication
(10) Pub. No.: US 2014/0155152 A1
(43) Pub. Date: Jun. 5, 2014

(54) PROVIDING FEEDBACK AT A GAMING MACHINE BASED ON A PHYSICAL IMPAIRMENT OF A PLAYER

(71) Applicant: IGT, Reno, NV (US)

(72) Inventor: Steven M. Waldner, Las Vegas, NV (US)

(73) Assignee: IGT, Reno, NV (US)

(21) Appl. No.: 13/692,751

(22) Filed: Dec. 3, 2012

(51) Int. Cl. A63F 13/02

(52) U.S. Cl. CPC A63F 13/02
USPC 463/31; 463/30; 463/35

(57) ABSTRACT

Systems and methods for providing feedback at a gaming machine may include operating the gaming machine in a first mode of operation. The first mode of operation comprises a first mode of providing sensory feedback to a first player regarding game play at the gaming machine. The method may further include receiving, from a second player, an indication of a sensory impairment of the second player. The sensory impairment relates to a first sense. The method may also include, based on the indication of the sensory impairment, operating the gaming machine in a second mode of operation. The second mode of operation comprises a second mode of providing sensory feedback to the second player regarding game play at the gaming machine. In the second mode of operation, the gaming machine provides enhanced sensory feedback to a second sense of the player. The second sense is different than the first sense.

### BACKGROUND

Many of today's gaming casinos and other entertainment locations feature different single and multi-player gaming systems such as slot machines and video poker machines. The gaming machines may include a number of hardware and software components to provide a wide variety of game types and game playing capabilities. Exemplary hardware components may include bill validators, coin acceptors, card readers, keypads, buttons, levers, touch screens, coin hoppers, ticket printers, player tracking units and the like. Software components may include, for example, boot and initialization routines, various game play programs and subroutines, credit and payout routines, image and audio generation programs, various component modules and a random or pseudo-random number generator, among others.

Gaming machines are highly regulated to ensure fairness. In many cases, gaming machines may be operable to dispense monetary awards of a large amount of money. Accordingly, access to gaming machines is often carefully controlled. For example, in some jurisdictions, routine maintenance requires that extra personnel (e.g., gaming control personnel) be notified in advance and be in attendance during such maintenance. Additionally, gaming machines may have hardware and software architectures that differ significantly from those of general-purpose computers (PCs), even though both gaming machines and PCs employ microprocessors to control a variety of devices. For example, gaming machines may have more stringent security requirements and fault tolerance requirements. Additionally, gaming machines generally operate in harsher environments as compared with PCs.

In many casinos and other entertainment locations, the gaming machines may be networked to one or more devices that monitor the functions of the gaming machines during operation. For example, a system may monitor and regulate the amount of money received by a gaming machine and the amount of money paid out by the gaming machine. The system may also monitor and regulate multi-player gaming, pooling of player wagers, etc. on the gaming machine. For example, networking and/or control software may be used to regulate game performance across all players, such as graphics that allows each player to participate in the same scene in the game. Networking and/or control software may be used to unify separate gaming machines such that the multi-player gaming may appear as one game to the system. Networking may also allow two or more gaming machines to be combined under the same model, which allows several players to play the same game, while at different gaming machines.

With the increasing popularity of ticket-based play, electronic gaming machine players that have physical impairments, such as blindness or other sensory impairment, have difficulty operating and/or continuing to play the wagering game on a gaming machine. Other players, such as senior citizens, may also experience difficulty when playing the wagering game. Conventionally, these groups of players relied on the feel and sound of currency, such as coins, to participate in the gaming experience. By using tickets, audible and tactile feedback of the coin-in/coin-out system has been reduced or eliminated.

### SUMMARY

According to various example embodiments, a method for providing sensory feedback at a gaming machine is disclosed. The method may include operating the gaming machine in a first mode of operation. The first mode of operation comprises a first mode of providing sensory feedback to a first player regarding game play at the gaming machine. The method may further include receiving, from a second player, an indication of a sensory impairment of the second player. The sensory impairment relates to a first sense. The method may also include, based on the indication of the sensory impairment, operating the gaming machine in a second mode of operation. The second mode of operation comprises a second mode of providing sensory feedback to the second player regarding game play at the gaming machine. In the second mode of operation, the gaming machine provides enhanced sensory feedback to a second sense of the player. The second sense being different than the first sense.

According to one example embodiment, a controller for a gaming machine is disclosed. The controller includes a processor configured to operate the gaming machine in a first mode of operation, wherein the first mode of operation comprises a first mode of providing feedback to a first player regarding gaming results at the gaming machine. The processor may also be configured to receive, from a second player, an indication of a physical impairment of the second player. The processor may be further configured to, based on the indication of the sensory impairment, operate the gaming machine in a second mode of operation, wherein the second mode of operation comprises a second mode of providing feedback to the second player regarding game play at the gaming machine, wherein, in the second mode of operation, the gaming machine provides enhanced feedback to the second player to accommodate the physical impairment.

According to another example embodiment, a computer-readable storage medium is disclosed. The storage medium has machine instructions stored therein, the instructions being executable by a processor to cause the processor to perform operations. The operations include operating the gaming machine in a first mode of operation, wherein the first mode of operation comprises a first mode of providing sensory feedback to a first player regarding game play at the gaming machine. The operations also include receiving, from a second player, an indication of a sensory impairment of the second player, the sensory impairment relating to a first sense. The operations further include, based on the indication of the sensory impairment, operating the gaming machine in a second mode of operation, wherein the second mode of operation comprises a second mode of providing sensory feedback to the second player regarding game play at the gaming machine, wherein, in the second mode of operation, the gaming machine provides enhanced sensory feedback to a second sense of the player, the second sense being different than the first sense.

### BRIEF DESCRIPTION OF THE DRAWINGS

The details of one or more implementations are set forth in the accompanying drawings and the description below. Other features, aspects, and advantages of the disclosure will become apparent from the descriptions, the drawings, and the claims, in which:

FIG. 1 is an illustration of a gaming machine, according to an exemplary embodiment;

FIG. 2 is an illustration of a gaming environment, according to an exemplary embodiment;

FIG. 3 is an illustration of an interface of a game machine, according to an exemplary embodiment;

FIG. 4 is an illustration of feedback being provided to the player that communicates current conditions of the wagering game, in accordance with an exemplary embodiment; and

FIG. 5 is a flow diagram of a method for providing feedback at a gaming machine, according to one embodiment

### DETAILED DESCRIPTION

Numerous specific details may be set forth below to provide a thorough understanding of concepts underlying the described embodiments. It may be apparent, however, to one skilled in the art that the described embodiments may be practiced without some or all of these specific details. In other instances, some process steps have not been described in detail in order to avoid unnecessarily obscuring the underlying concept.

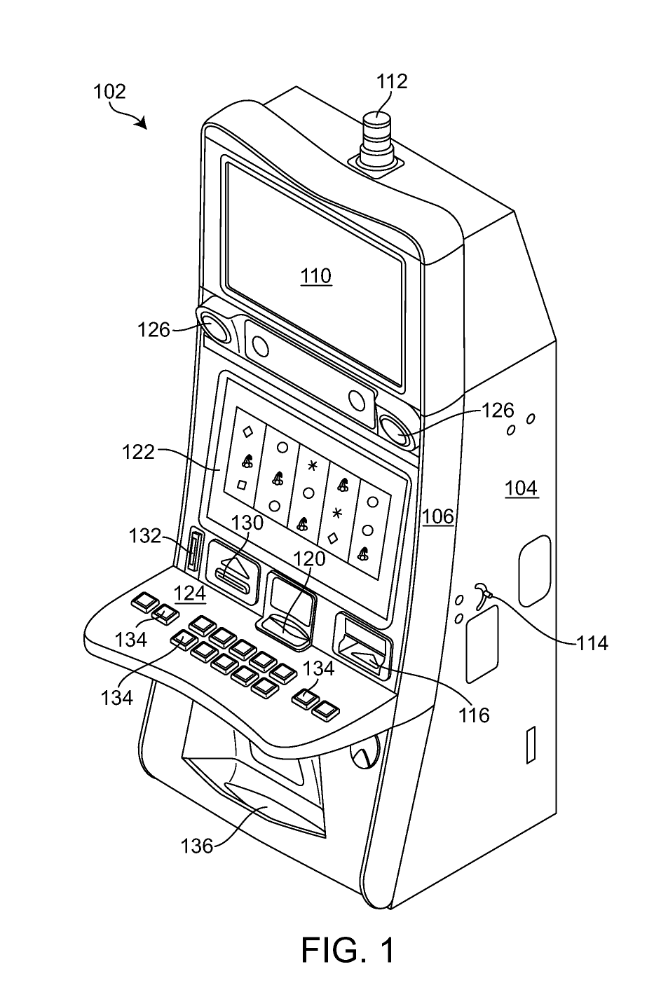

Referring to FIG. 1, a perspective drawing of an electronic gaming machine 102 is shown in accordance with described embodiments. Gaming machine 102 may include a main cabinet 104. Main cabinet 104 may provide a secure enclosure that prevents tampering with device components, such as a game controller (not shown) located within the interior of main cabinet 104. Main cabinet 104 may include an access mechanism, such as a door 106, which allows the interior of gaming machine 102 to be accessed. Actuation of a door 106 may be controlled by a locking mechanism 114. In some embodiments, locking mechanism 114, door 106, and the interior of main cabinet 104 may be monitored with security sensors of various types to detect whether the interior has been accessed. For instance, a light sensor may be provided within main cabinet 104 to detect a change in light-levels when door 106 is opened and/or an accelerometer may be attached to door 106 to detect when door 106 is opened.

Gaming machine 102 may include any number of user interface devices that convey sensory information to a user and/or receive input from the user. For example, gaming machine 102 may include a first electronic display 110, a second electronic display 122, speakers 126, and/or a candle device 112 to convey information to the user of gaming machine 102. Gaming machine 102 may also include a console 124 having one or more inputs 134 (e.g., buttons, track pads, etc.) configured to receive input from a user. A controller (not shown) within gaming machine 102 may run a game, such as a wager-based game, in response to receiving input from a user via inputs 134 or displays 110, 122. For example, inputs 134 may be operated to place a wager in the game and to run the game. In response, the controller may cause reels shown on display 122 to spin, such as with a slot game, and/or display 110 to display the results of the game.

Gaming machine 102 may also include devices for conducting a wager-based game. For example, gaming machine 102 may include a ticket acceptor 116 and a printer 120. In various embodiments, gaming machine 102 may be configured to run on credits that may be redeemed for money and/or other forms of prizes. Ticket acceptor 116 may read an inserted ticket having one or more credits usable to play a game on gaming machine 102. For example, a player of gaming machine 102 may wager one or more credits within a video slot game. If the player loses, the wagered amount may be deducted from the player's remaining balance on gaming machine 102. However, if the player wins, the player's balance may be increased by the amount won. Any remaining credit balance on gaming machine 102 may be converted into a ticket via printer 120. For example, a player of gaming machine 102 may cash out of the machine by selecting to print a ticket via printer 120. The ticket may then be used to play other gaming machines or redeemed for cash and/or prizes. According to various embodiments, gaming machine 102 may record data regarding its receipt and/or disbursement of credits. For example, gaming machine 102 may generate accounting data whenever a result of a wager-based game is determined. In some embodiments, gaming machine 102 may provide accounting data to a remote data collection device, allowing the remote monitoring of gaming machine 102.

In one embodiment, gaming machine 102 may include a loyalty card acceptor 130. In general, a loyalty card may be tied to a user's loyalty account. A loyalty account may store various information about the user, such as the user's identity, the user's gaming preferences, the user's gaming habits (e.g., which games the user plays, how long the user plays, etc.), or similar information about the user. A loyalty account may also be used to reward a user for playing gaming machine 102. For example, a user having a loyalty account may be given a bonus turn on gaming machine 102 or credited loyalty points for playing gaming machine 102. Such loyalty points may be exchanged for loyalty rewards (e.g., a free meal, a free hotel stay, a free room upgrade, discounts, etc.).

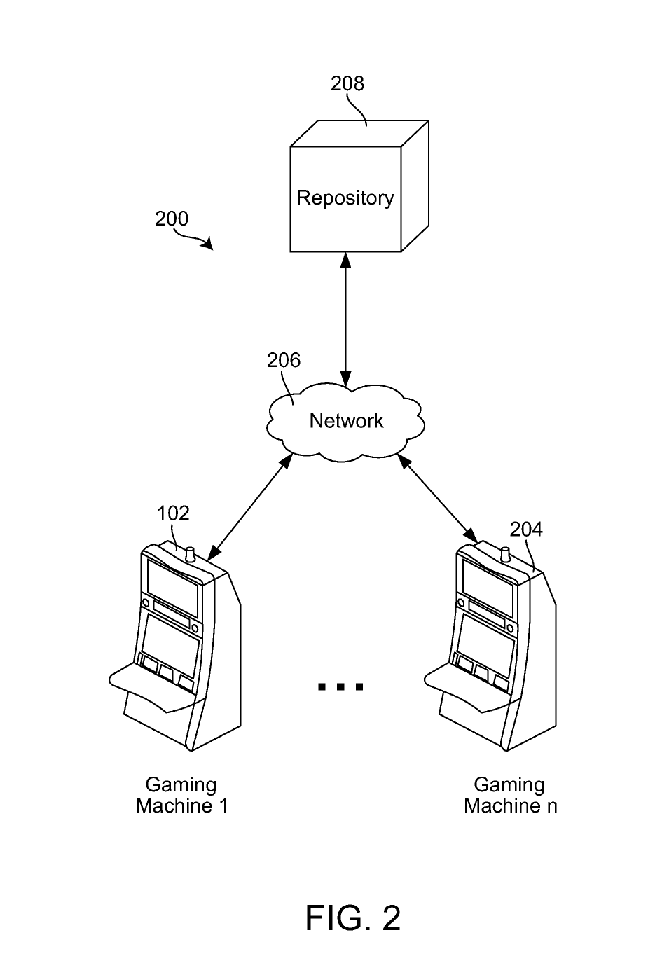

Referring now to FIG. 2, an illustration of a gaming environment 200 is shown, according to an exemplary embodiment. Gaming environment 200 may be within, for example, a casino, a racetrack, a hotel, or other entertainment location. As shown, gaming environment 200 may include any number of gaming machines. For example, gaming environment 200 may include gaming machine 102 shown in FIG. 1 through a gaming machine 204 (i.e., a first gaming machine through nth gaming machine). Gaming environment may also include a network 206 through which gaming machines 102, 204 communicate with a repository 208. In some embodiments, gaming machines 102, 204 may also communicate with each other via network 206.

Network 206 may be any form of communications network that conveys data between gaming machines 102, 204 and repository 208. Network 206 may include any number wired or wireless connections. For example, repository 208 may communicate over a wired connection that includes a serial cable, a fiber optic cable, a CAT5 cable, or any other form of wired connection. Similarly, repository 208 may communicate via a wireless connection (e.g., via WiFi, cellular, radio, etc.). Network 206 may also include any number of intermediary networking devices, such as routers, switches, servers, etc.

Repository 208 may be one or more electronic devices connected to network 206 configured to collect data from gaming machines 102, 204. For example, repository 208 may be a single computer, a collection of computers, or a data center. Repository 208 may include one or more data storage devices in communication with one or more processors. The data storage devices may store machine instructions that, when executed by the one or more processors, cause the one or more processors to perform the functions described with regard to repository 208. Generally, repository 208 is configured to receive and store data regarding gaming machines 102, 204 and to provide the data to a user interface (e.g., a display, a handheld device, etc.). In some cases, repository 208 may perform data analysis on the received data. For example, repository 208 may determine averages, trends, metrics, etc., for one or more of gaming machines 102, 204. Data may be sent by gaming machines 102, 204 to repository 208 in real-time (e.g., whenever a change in credits or cash occurs, whenever another type of system event occurs, etc.), periodically (e.g., every fifteen minutes, every hour, etc.), or in response to a request from repository 208.

The data received by repository 208 may include operational data. In general, operational data may be any other form of data indicative of the operational state of gaming machines 102, 204. For example, operational data may include data indicative of the number of games played on gaming machines 102, 204, the types of games played on gaming machines 102, 204, errors or alerts generated by gaming machines 102, 204, whether gaming machines 102, 204 are currently in use, etc. Repository 208 may use the received operational data to allow gaming machines 102, 204 to be monitored. Repository 208 may also provide notifications, if maintenance is required for any of gaming machines 102, 204. For example, a notification may be sent to a display (e.g., a display attached to repository 208, a display of a handheld device operated by a technician, etc.), so that an error may be corrected.

In some embodiments, the data received by repository 208 may include data related to a user's loyalty account. For example, a user of gaming machine 102 may link their loyalty account to gaming machine 102, so that she can gain loyalty points, free turns, etc., while playing gaming machine 102. A user may link his or her loyalty account to gaming machine 102 in any number of ways. For example, the user may insert a loyalty card into gaming machine 102 and/or provide biometric data to gaming machine 102 (e.g., by conducting a finger print scan, a retinal scan, etc.). In some cases, a mobile device operated by the user may provide data regarding the user's loyalty account to gaming machine 102. The mobile device may transfer data to gaming machine 102 wirelessly (e.g., via Bluetooth, WiFi, etc.), via a wired connection (e.g., via a USB cable, a docking station, etc.), via the user's body (i.e., the mobile device transmits data through the user's body and into gaming machine 102), or in another manner. Repository 208 may then associate the user's time playing gaming machine 102 with the user's loyalty account (e.g., to add loyalty points to the user's account, to provide certain rewards to the user, such as a bonus turn, etc.).

Repository 208 may provide data to gaming machines 102, 204 via network 206. For example, repository 208 may notify a user of gaming machine 102 that the user qualifies for a loyalty award, such as a free meal, a free night in a hotel, a discount, a bonus turn, and so on. In some cases, repository 208 may provide a service window to gaming machines 102, 204. For example, the service window may appear within a Flash application executed by gaming machines 102, 204 via the lower display of the machines. A service window may allow notifications to be provided by repository 208 to an individual user during game play.

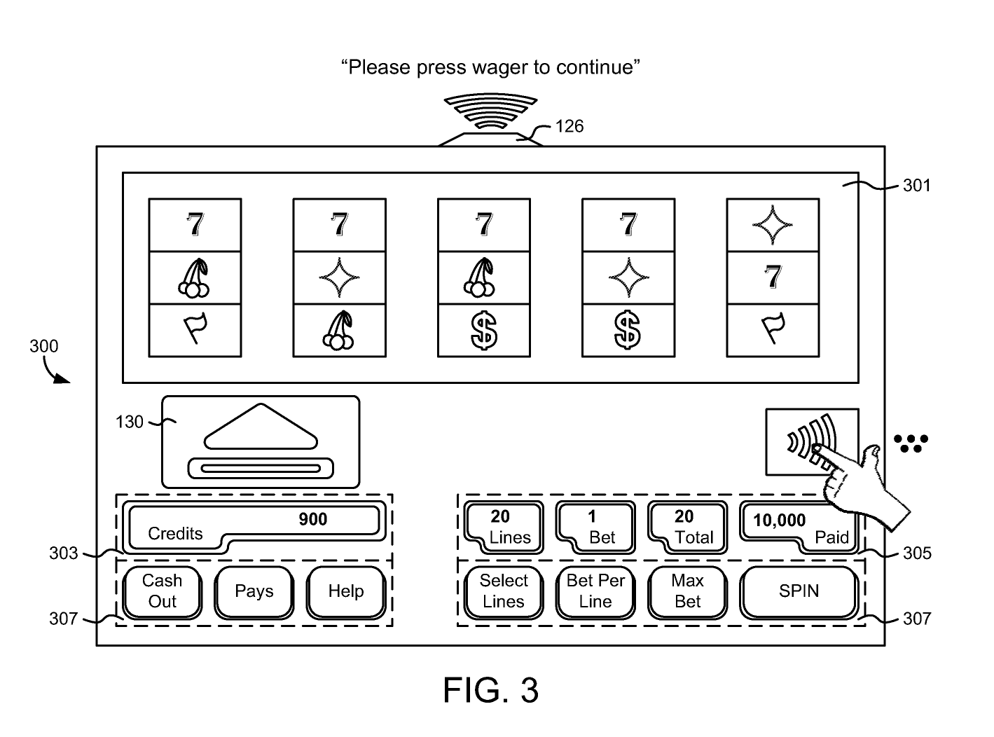

FIG. 3 is an illustration of an interface 300 of a game machine, in accordance with an exemplary embodiment. The interface 300 may include display screen 301 for providing the wagering game. The display screen 301 may, for example, be shown on display 122. The display screen 301 may show the current status of the game to the player, e.g., the player's current slot arrangement. Although a slot game is shown, other games may also be shown or provided, such as video poker, roulette, keno, etc.

Interface 300 may include section 303, which includes the credits/awards won for various achievements within the game. Section 305 may include statistics for the player. For example, section 305 may include indicators (e.g., tactile, touch screen, overlay, etc.) for the number of wagers that have been placed, how many credits the player has, the percentage of wins, and so forth. Section 305 may include more or less indicators depending on the configuration of the gaming machine 102.

Section 307 may include actions that the player can take within the game. For example, section 307 may include indicators (e.g., tactile, touch screen, overlay, etc.) for the maximum wager, the number of credits needed to wager, or whether to double the bet, whether to collect any awards, whether to deal/wager, and so forth. Section 307 may include more or less indicators depending on the configuration of the gaming machine.

Interface 300 may include other devices such as display 110, speakers 126 and candle device 112 (shown in FIG. 1) to provide feedback regarding game play to the player. Such feedback may be provided, for example, when a button on the EGM is depressed, when the EGM requires the player to act, when the game has completed, when the player has won and how much they have won, and so on. Such feedback may also provide information regarding the current machine credit meter, the condition of the game, and so on.

In an example embodiment, the gaming machine 102 has multiple modes of operation in which various modes of providing feedback to players are utilized. For example, in a first mode of operation, the gaming machine 102 may provide feedback using the displays 110, 122, speakers 126, and candle device 112 in a manner which stimulates the senses (sight, sound, touch, etc.) of a typical player that does not have any particular physical impairments. In another mode of operation, the gaming machine 102 may provide sensory feedback that is enhanced in some fashion. For example, if the player is visually impaired (e.g., blind), the gaming machine 102 may provide enhanced sensory feedback to a different sense of the player (e.g., hearing). For example, the gaming machine 102 may utilize speakers 126 to provide computer-generated voice feedback to the player. As another example, for a player that is hearing impaired, enhanced visual feedback may be provided. For example, certain information that would otherwise be communicated via speakers 126 may be communicated via display screen 110 or display screen 122. For example, a message indicating that the player has won a game may be more prominently displayed to accommodate the fact that the player may be unable to hear the auditory feedback otherwise provided via speakers 126,

The gaming machine 102 may enter the enhanced feedback mode of operation in response to receiving an indication of a sensory impairment of a player. In one implementation, the gaming machine 102 may enter the enhanced feedback mode of operation responsive to information contained in a loyalty card provided by the player. The player's loyalty card may include information about the player's impairment. For example, the player may have entered this information when applying for the loyalty card or at any time after applying for the card, such as during play of the wagering game. A patron management system may provide a flag (true/false) which attaches to the profile of the player via the loyalty card. The flag may be toggled when the player enrolls in the patron management system, such as the loyalty card. The flag may indicate the impairment of the player. As another example, the loyalty card may identify the player, and information regarding the player may be retrieved from repository 208 and provided to the gaming machine 102 via network 206.

Once the loyalty card is provided, the flag may be passed to the gaming system so that the gaming machine 102 may provide enhanced feedback. For example, if the player uses their loyalty account at any gaming machine within the gaming environment, then gaming machine 102 will recognize the indication of the physical impairment and provide feedback accordingly. As long as the loyalty card is used by the player, the flag will be set to true and the system will continue to provide enhanced feedback. In other implementations, the loyalty card may also provide information as to the player's primary language, which is provided to the gaming machine 102 to indicate the language of the enhanced feedback. Gaming machine 102 may provide the enhanced feedback in the primary language of the user.

In another implementation, interface 300 may include an option to select enhanced feedback from the gaming machine at interface 312. For example, an input device (e.g., button, a touch screen input, an overlay (pop-up screen), etc.) may be configured to receive input indicating whether the player has a physical impairment. In some implementations, an assistive system, such as Braille, may be used to direct the player toward the input device If the player does not select the enhanced feedback option, then the player may continue to play at the gaming machine or discontinue play with the gaming machine operating without enhanced feedback.

In FIG. 3, an indication of a physical impairment of the player has been received. For example, once the player provides the loyalty card indicating impairment or selects feedback option via interface 312, the gaming machine may provide enhanced feedback. The feedback provided in FIG. 3 signals to the player that the feedback option has been selected and that a wager should be provided by the player. The feedback may be audibly communicated to the user via device 310. In other words, device 310 may provide an audible communication to the player when any indicator on the gaming machine is selected (e.g., a depressed button).

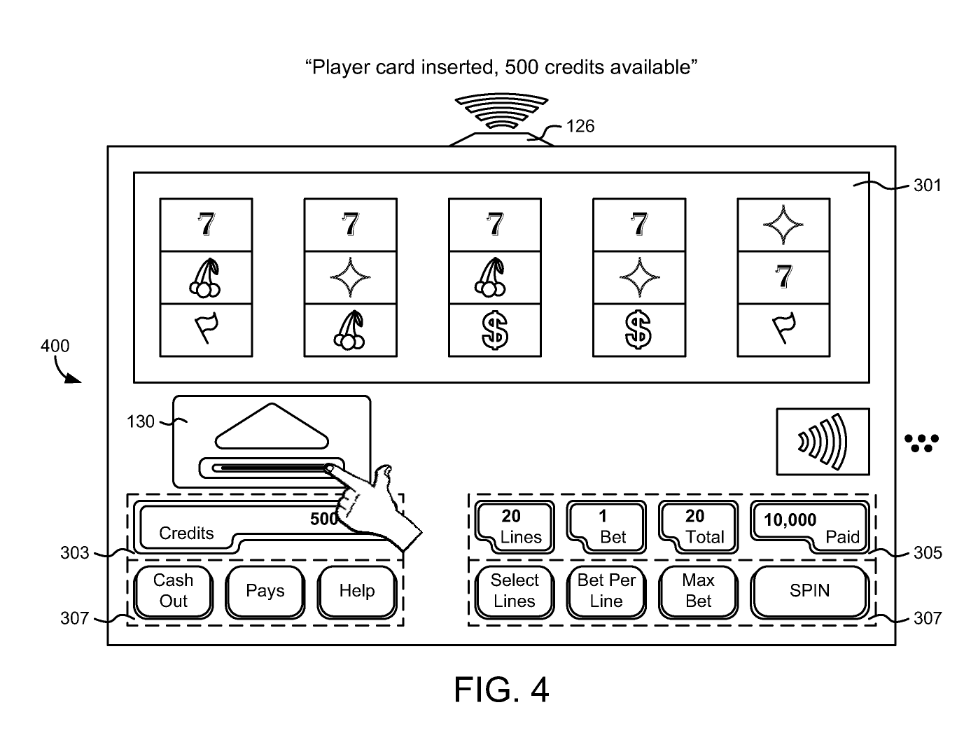

FIG. 4 illustrates feedback being provided to the player that communicates current conditions of the wagering game, in accordance with an exemplary embodiment. For example, device 310 may audibly communicate feedback to the player related to the player's actions within the game and parameters related to the player's actions, such as inserting a player card and the number of credits available on the card in response to the insertion of the card. In other examples, when the player inserts cash or coin into the gaming machine, then device 310 may provide feedback related to the amount inserted and the current credit meter. In other examples, device 310 may audibly communicate to the player the jackpot, when the player has won and the amount the player has won, when the game has been completed, etc. When the player cashes out, then a ticket may be printed and device 310 may audibly communicate that the ticket has been printed and the cash value currently on the ticket.

Once the impaired player leaves the gaming machine, e.g., withdraws the loyalty card, the gaming machine may default back to a standard mode of operation, such as without the enhanced cues. In another implementation, the impaired player may unselect the enhanced cues while playing at gaming machine 102.

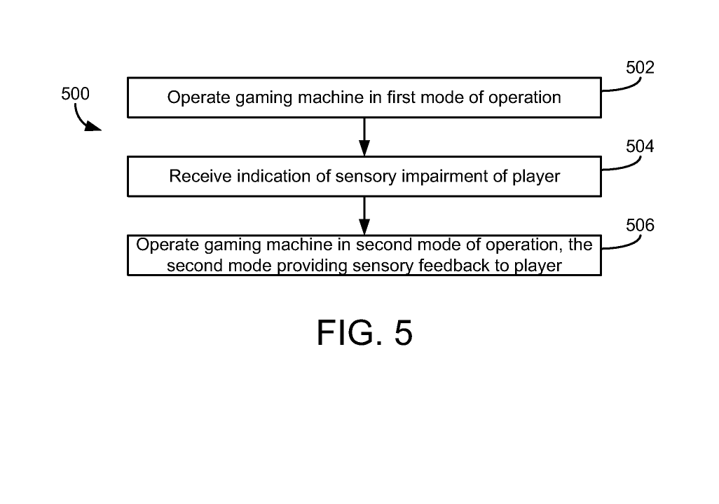

Referring now to FIG. 5, flow diagram of a process 500 for providing a wagering agent is shown, according to an exemplary embodiment. Process 500 may be implemented by one or more processors executing machine instructions stored within one or more computer storage devices. For example, process 500 may be implemented by a gaming machine, such as gaming machine 102 shown in FIGS. 1 and 2.

At 502, the gaming machine 102 operates in a first mode of operation. The first mode of operation may include providing sensory feedback to a first player regarding game play at the gaming machine. The feedback may include visual, audio, tactile, or any other appropriate feedback based on the indication of the physical impairment. In one example, the gaming machine 102 operates in the first mode of operation for players for whom no indication of a physical impairment has been received.

At 504, when a player with a physical impairment interacts with the gaming machine, an indication of a physical impairment may be received. For example, the player may insert a loyalty card, provide an input via an input device, etc., to provide the indication of the sensory impairment In the example of a loyalty card, player account information may also be received along with the indication of the sensory impairment (.e.g, from the card itself, from the repository 208, etc.). In some embodiments, for example, the account information may include an indication of a primary language of the second player. The feedback may then be provided in the primary language of the second player.

At 506, based on the indication of the sensory impairment, the gaming machine operates in a second (enhanced feedback) mode of operation. The second mode of operation may include a second mode of providing sensory feedback to the second player regarding game play at the gaming machine. In the second mode of operation, the gaming machine may provide enhanced sensory feedback to a different sense of the player. For example, the gaming machine 102 may provide enhanced auditory feedback for a visually impaired player, enhanced visual feedback for a hearing impaired player, and so on.

In some embodiments, physical impairments of the player may be accommodated in other ways. For example, the display of the gaming machine may have an optimum viewing angle which may be adjusted to accommodate a player that is in a mobility device. As another example, the display of the gaming machine may be tilted or lowered for someone who is in a mobility device.

The gaming machine may default to a standard mode of operation once the first or the second player terminates game play at the machine, such as withdrawing their loyalty card. In another implementation, the first or the second player may turn off the sensory feedback.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing agent. Alternatively or in addition, the program instructions can be encoded on an artificially-generated propagated signal, e.g., a machine-generated electrical, optical, or electromagnetic signal, that is generated to encode information for transmission to suitable receiver agent for execution by a data processing agent. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible and non-transitory.

The operations described in this specification can be implemented as operations performed by a data processing agent on data stored on one or more computer-readable storage devices or received from other sources.

The term “client or “server” include all kinds of agent, devices, and machines for processing data, including by way of example a programmable processor, a computer, a system on a chip, or multiple ones, or combinations, of the foregoing. The agent can include special purpose logic circuitry, e.g., an FPGA (field programmable gate array) or an ASIC (application-specific integrated circuit). The agent can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The agent and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and agent can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

1. A computer-implemented method for providing sensory feedback at a gaming machine comprising:
operating the gaming machine in a first mode of operation, wherein the first mode of operation comprises a first mode of providing sensory feedback to a first player regarding game play at the gaming machine;
receiving, from a second player, an indication of a sensory impairment of the second player, the sensory impairment relating to a first sense; and
based on the indication of the sensory impairment, operating the gaming machine in a second mode of operation, wherein the second mode of operation comprises a second mode of providing sensory feedback to the second player regarding game play at the gaming machine, wherein, in the second mode of operation, the gaming machine provides enhanced sensory feedback to at least a second sense of the second player, the second sense being different than the first sense, and wherein the enhanced sensory feedback at least partially comprises tactile feedback perceptible by the second player to determine one or more conditions of game play.

2. The method of claim 1, wherein the sensory feedback comprises at least one of visual, audio, or tactile feedback.

3. The method of claim 1, wherein the first sense is a sense of sight and wherein the second sense is the sense of hearing.

4. The method of claim 1, wherein receiving the indication of the sensory impairment further comprises receiving player account information.

5. The method of claim 4, wherein the indication is received via a loyalty card.

6. The method of claim 1, further comprising:
receiving, from a server, an indication of a primary language of the second player.

7. The method of claim 6, wherein the enhanced feedback is provided in the primary language of the second player.

8. The method of claim 1, wherein the gaming machine defaults to a standard mode of operation once the first or second player terminates game play.

9. A controller for a gaming machine comprising:
a processor configured to:
operate the gaming machine in a first mode of operation, wherein the first mode of operation comprises a first mode of providing feedback to a first player regarding gaming results at the gaming machine;
receive, from a second player, an indication of a physical impairment of the second player; and
based on the indication of the sensory impairment, operate the gaming machine in a second mode of operation, wherein the second mode of operation comprises a second mode of providing feedback to the second player regarding game play at the gaming machine, wherein, in the second mode of operation, the gaming machine provides enhanced feedback to the second player to accommodate the physical impairment, and wherein the enhanced feedback at least partially comprises tactile feedback perceptible by the second player to determine one or more conditions of game play.

10. The controller of claim 9, wherein the feedback comprises at least one of visual, audio, or tactile feedback.

11. The controller of claim 9, wherein the physical impairment is a sensory impairment.

12. The controller of claim 9, wherein receiving the indication of the physical impairment further comprises receiving player account information.

13. The controller of claim 12, wherein the indication is received via a loyalty card.

14. The controller of claim 9, wherein the processor is further configured to:
receive, from a server, an indication of a primary language of the second player.

15. The controller of claim 14, wherein the enhanced feedback is provided in the primary language of the second player.

16. The controller of claim 9, wherein the gaming machine defaults to a standard mode of operation once the first or second player terminates game play.

17. A non-transitory computer-readable storage medium having machine instructions stored therein, the instructions being executable by a processor to cause the processor to perform operations comprising:
operating the gaming machine in a first mode of operation, wherein the first mode of operation comprises a first mode of providing sensory feedback to a first player regarding game play at the gaming machine;
receiving, from a second player, an indication of a sensory_impairment of the second player, the sensory impairment relating to a first sense; and
based on the indication of the sensory impairment, operating the gaming machine in a second mode of operation, wherein the second mode of operation comprises a second mode of providing sensory feedback to the second player regarding game play at the gaming machine, wherein, in the second mode of operation, the gaming machine provides enhanced sensory feedback to at least a second sense of the player, the second sense being different than the first sense, and wherein the enhanced sensory feedback at least partially comprises tactile feedback perceptible by the second player to determine one or more conditions of game play.

18. The non-transitory computer readable medium of claim 17, wherein the sensory feedback comprises at least one of visual, audio, or tactile feedback.

19. The non-transitory computer readable medium of claim 17, wherein the first sense is a sense of sight and wherein the second sense is the sense of hearing.

20. The non-transitory computer readable medium of claim 17, wherein receiving the indication of the sensory impairment further comprises receiving player account information.
